(19) United States
(12) Patent Application Publication
(10) Pub. No.: US 2020/0093328 A1
(43) Pub. Date: Mar. 26, 2020

(54) POTS, PANS, AND FRYING PANS WITH INSULATED BOTTOM

(71) Applicant: Halina Gaudyn, Park Ridge, IL (US)

(72) Inventor: Halina Gaudyn, Park Ridge, IL (US)

(21) Appl. No.: 16/136,819

(22) Filed: Sep. 20, 2018

(51) Int. Cl. A47J 36/36; A47J 27/00; A47J 27/022; A47J 36/02

(52) U.S. Cl. CPC A47J 36/36; A47J 36/02; A47J 27/022; A47J 27/002

(57) ABSTRACT

A cooking vessel for energy efficient cooking using a gas burner is disclosed. Said cooking vessel having an upper portion having a sidewall and a bottom, the sidewall and bottom defining a cooking chamber, a lower portion, the lower portion connected to the upper portion and extending downwardly along the same plane as the sidewall, the lower portion extending past the bottom of the upper portion such that the bottom of the upper portion is suspended when the cooking vessel is placed on a flat surface, forming a heating chamber under the cooking chamber, and wherein the lower portion allows airflow through the heating chamber.

### FIELD OF THE INVENTION

The present disclosure generally relates cookware. More specifically this application relates to stovetop pots and pans for use with gas burners.

### BACKGROUND

The general subject matter for this invention relates to the technical field of cooking utensils and, more specifically, relates to providing pots and pans with elevation. It is universal that in the cooking of certain liquid containing food items, that require boiling, the use of a pot to contain the food item is used over an open gas flame. This practice has been conducted for virtually centuries. The shortcomings in this method is that although a pot placed over an open flame receives heat directly to its bottom to heat the contents of the pot, a great amount of heat is lost along the edge of the pot and the heat is dissipated to atmosphere. This is a very inefficient use of natural gas, while at the same time releasing unwanted heat into the atmosphere of the kitchen or wherever the heating is taking place.

There is therefore a need in the industry to provide a design for a heating container, such as a metal pot, which improves substantially the efficiency of heat conduction from the gas burner into the pot, causing the liquid or substance to rise higher in temperature at a faster pace, thus saving energy.

Previous devices have attempted to solve this problem with varying degrees of success, however none have fully addressed the issues. Examples follow.

US Patent App No. 2003/0132221 by Ho discloses an electrical cooking appliance having electrical heating means, temperature sensing means, a first temperature sensitive switch connected to the temperature sensing means and connected to the electrical heating means arranged to open on sensing a first predetermined temperature and arranged in parallel with current limiting means, a second temperature sensitive switch connected to the temperature sensing means and connected in series with the electrical heating means arranged to open at a second predetermined temperature higher than the first temperature.

US Patent App No. 2004/001135 by Aspinwall discloses a heating vessel comprises a chamber having enclosed sides, a thermally conductive bottom end and a top end forming an opening for the introduction and extraction of contents to be heated, the bottom end having an external bottom side. A heater comprises a heat exchanger and a heat source having a heat outlet disposed at a fixed distance from the external bottom side and configured to deliver heat to a central area thereof. The heat exchanger includes a series of thermally conductive radially disposed fins are coupled circumferentially about the central area of the external bottom side, the fins extending for a fixed distance to encase the heat outlet. A gas flow path is formed to allow intake of air and output of exhaust.

US Patent App No. 2005/0199623 by Skinner discloses a container system includes interchangeable components to form an enclosed container. A base in the form of a pallet, a sidewall and a cover are assembled to form an enclosed container. The containers include nesting portions on the pallet and cover so that containers may be stacked when assembled and the components may also be stacked when in storage and nest to resist lateral sliding. The sidewalls include a first embodiment with single wall construction and a second embodiment with double wall construction. The walls are a corrugated plastic construction and include spaced apart reinforcing rods extending into the flutes. The double wall sidewall includes an inner wall with vertically extending flutes having reinforcing rods inserted into spaced apart ones of the flutes while the outer wall has horizontally extending flutes with one or more reinforcing rods inserted therein to provide added strength. The two versions of the sidewall are interchangeable and nest into receiving channels formed in the cover and the pallet.

US Patent App No. 2007/0193575 by Jan discloses a container includes a body and a heat concentration assembly securely formed on the bottom face of the body. The heat concentration assembly is composed of multiple protrusions formed on the bottom face of the body. The protrusions on the bottom face of the body absorb heat from a heating device and deliver the absorbed heat directly to the bottom face of the body to reduce heating time.

US Patent App No. 2008/0029082 by Dowst et al discloses a portable heating assembly, in which a heating utensil is supported on an upper surface of a utensil support, there is included a heat transfer element attached to a bottom surface of the heating utensil for both enhancing the heat transfer to the heating utensil and centering the heating utensil on the utensil support by engaging the periphery of the utensil support. Various shapes and placement configurations are provided with the heat transfer element being placed on either the radially inner or the radially outer side of the utensil support. Accommodation is also made for storage of the various components within the internal confines of the heating utensil.

US Patent App No. 2008/0223359 by Huang discloses energy efficient cookware is provided includes a base and a wall, a linear pattern of flame guide channels connected to the base bottom. The guide channels accept a flame and guides it to the perimeter from the central region resulting efficient heat exchange; The linear channel profiles provides maximum the surface enhancement from a given plain area on the bottom to improve heat transfer while provides even heating, and mechanical strength to the cookware; The impedance to entrance of flame flow into the channels is minimized to allow easy entrance of the flame into the channels; A square base further extends the linear channel length to gain extra efficiency. A method of making the efficient cookware is provided involving welding an extruded channel base to a wall.

US Patent App No. 2010/026884 by Tunstall discloses a pot, having a bottom and a continuous sidewall, defining a fluid or substance containing space therein. The pot further includes a plurality of fins extending along the bottom exterior surface of the pot, in various configurations, but preferably in a series of raised, curved arms that radiate out from the center of the pot and terminate at its outer edge, defining a plurality of spaces between each radiating arm. This configuration of raised, radiating arms along the exterior bottom wall of the pot increase the surface area of the bottom of the pot and absorbs the heat from the gas burner into the pot, thereby increasing the heating performance of the liquid or substance being heated therein. There may be further provided small mounds or waves on the interior bottom of the pot for further increasing the surface of the pot interior, which helps channel the heat in a circular motion, and helps induction of heat into the substance. A second embodiment includes a plurality of metal dowel members secured to the bottom of a container to absorb the heat from the gas burner into the pot, thereby increasing the heating performance of the liquid or substance being heated therein.

U.S. Pat. No. 4,832,295 by Wagner discloses a fondue stand having four vertically upstanding partition walls defining upper edge surfaces upon which is supported a fondue pot. The vertical partition walls are angularly spaced apart on a main supporting frame such that, when the fondue pot is supported on the upper edge surfaces, the partition walls lie in vertical planes offset from, or at an angle to, the vertical planes containing the diameters of the circular cross section of the fondue pot. In an alternative embodiment, a security ring for a stove range is provided, with the main body portion being circular and having a central cutout from which extends a hollow central hub insertable into the circular opening of the range of the stove, for supporting pots and pans in a safe manner on the range.

U.S. Pat. No. 5,564,589 by Fu discloses a more efficient flat bottom pot or pan is obtained by (a) the introduction of an initial central downward depression in the bottom plate in the order of twice the plate thickness to avoid the undesirable upward bulging of the pot bottom as a result of aging, (b) providing heat transferring fins in a spiral pattern to the bottom and helical pattern to the side wall of the pot or pan for more effective heat transfer from the stove flame to the pot or pan, and to stabilize the pot with its central depression for placement on flat surfaces, and (c) providing a detachable shielding skirt around the pot to reduce the heat loss from radiation and convection.

While guidelines for cookware suggest various safety concerns with cookware to prevent fires, burns and explosions, none of the previously disclosed art encompasses all the energy saving and safety features in the present invention.

These problems, and others, are addressed by the present invention and discussed in greater detail below.

### BRIEF SUMMARY

Currently-available devices lack many of the proposed features described below. The pot and/or pan with insulated bottom of the present disclosure users to insulate a traditional burner both increasing energy efficiency and reducing the heating effect a burner can have on the kitchen. In addition, the present set of devices can reduce cleanup time by preventing spillage into the burners and by reducing the amount of heat applied to spillage on the stovetop.

The pots, pans, and frying pans disclosed herein is therefore a traditionally shaped pot with a metallic skirt extending downwardly to cover the gap between a traditional pot and a stovetop. Therefore from a side-on view the burner would be obscured from view by the skirt, insulating the flame from the kitchen as a whole and directing heat upwards towards the cooking vessel.

The advantages of such an application become clear when one is experienced in cooking, cleaning, and other related fields. Typical devices currently on the market do not have the confluence and plethora of features contemplated and described herein.

In a first embodiment the disclosure contemplates a cooking vessel for energy efficient cooking using a gas burner having an upper portion having a sidewall and a bottom, the sidewall and bottom defining a cooking chamber, a lower portion, the lower portion connected to the upper portion and extending downwardly along the same plane as the sidewall, the lower portion extending past the bottom of the upper portion such that the bottom of the upper portion is suspended when the cooking vessel is placed on a flat surface, forming a heating chamber under the cooking chamber, and wherein the lower portion allows airflow through the heating chamber.

In a second embodiment the disclosure contemplates a cooking pot having a round bottomed pot, the round bottomed pot having a rounded bottom and a circular sidewall, the sidewall and bottom forming a cooking chamber, and a circular skirt, the skirt connected to the sidewall and extending downwardly beyond the bottom of the round bottomed pot, thereby forming a heating chamber below the round bottomed pot.

In another embodiment the disclosure contemplates a method for cooking foodstuffs using a gas-powered stove the method having the steps of providing a cooking vessel, the cooking vessel having an upper portion having a sidewall and a bottom, the sidewall and bottom defining a cooking chamber; a lower portion, the lower portion connected to the upper portion and extending downwardly along the same plane as the sidewall, the lower portion extending past the bottom of the upper portion such that the bottom of the upper portion is suspended when the cooking vessel is placed on a flat surface, forming a heating chamber under the cooking chamber; and wherein the lower portion allows airflow through the heating chamber, placing the cooking vessel on the gas-powered stove such that the heating chamber is placed over a gas burner, igniting the gas burner, placing foodstuffs into the cooking chamber; and cooking said foodstuffs.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1 is a perspective view of an exemplary pot according to the present disclosure.

FIG. 2 is a bottom perspective view of a first embodiment of a pot skirt according to the present disclosure.

FIG. 3 is a bottom perspective view of a second embodiment of a pot skirt according to the present disclosure.

FIG. 4 is a side-on cutaway view of an exemplary pot according to the present disclosure.

FIG. 5 a side-on cutaway view of an exemplary pan according to the present disclosure.

### DETAILED DESCRIPTION

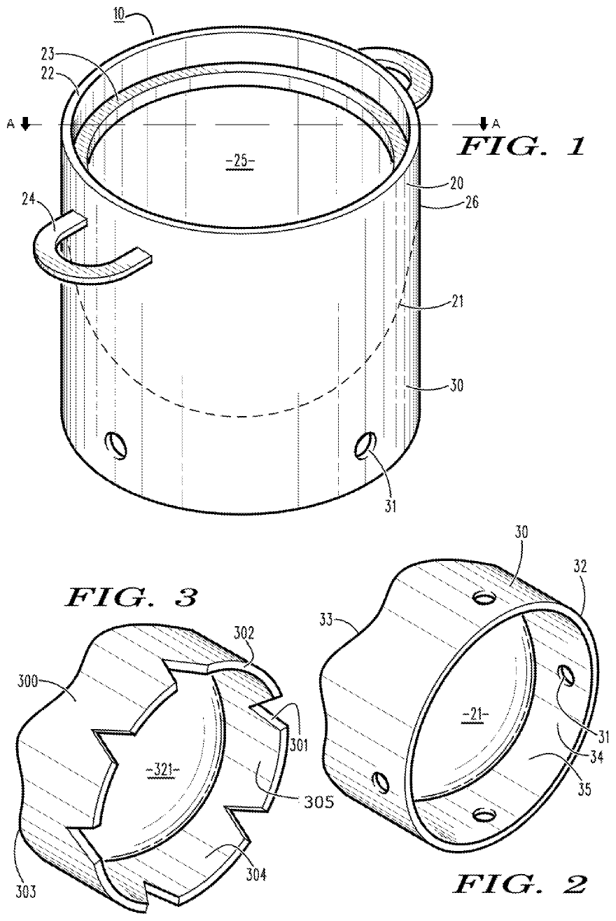

Referring now the drawings with more specificity, the present invention essentially provides an improved, insulated, set of pots, pans and related apparatus. The preferred embodiments of the present invention will now be described with reference to FIGS. 1-5 of the drawings. Variations and embodiments contained herein will become apparent in light of the following descriptions.

Looking now to FIGS. 1 & 2 an exemplary pot 10 according to the present invention, is shown. As described herein, pot 10 has a top portion 20 and bottom portion 30. Top portion 20 will ordinarily have a bottom 21, top edge 22, lip 23, handles 24, and chamber 25. The chamber 25, as with most typical pots is where food can be cooked by a user. Bottom portion 30 connects to top portion 20 at or around the end 26 of bottom 21's curature (if the bottom 21 is curved). Bottom Portion 30 then extends downwardly past the apex of curve 21 such that when laid on a flat surface pot 10 will rest only on bottom portion 30, and bottom 21 will not be touching the flat surface. Holes 31 provide for airflow within the bottom portion 30. Looking more closely at FIG. 2 bottom portion 30 is shown in greater detail. In this view it can be seen that bottom edge 32 is where pot 10 will stand when places on a flat surface, and edge 33 is where the bottom portion 30 connects to top portion 20. Thus, a chamber 35 is defined by inner edge 34 and pot bottom 21.

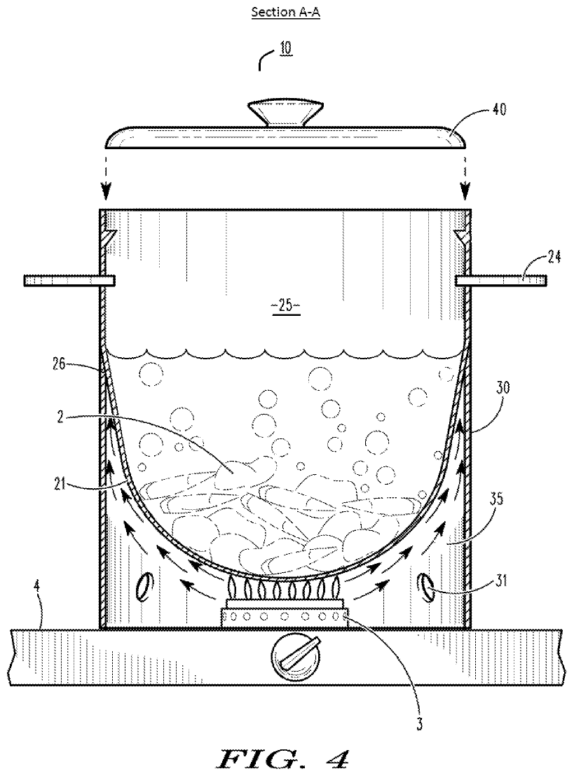

Looking now to FIG. 3, an alternative embodiment for bottom portion 30 and pot 10 is shown. In this embodiment bottom portion 300 no longer incorporates holes 31, but instead utilizes cut-outs 301. In this view it can be seen that bottom edge 32 is where pot 10 will stand when places on a flat surface, and edge 303 is where the bottom portion 300 connects to the pot. Thus, a chamber 305 is defined by inner edge 304 and pot bottom 321.

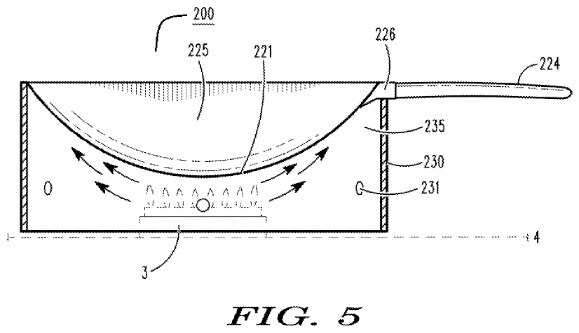

FIG. 4 further shows features of pot 10 in a cutaway format. As can be seen food 2 is cooking within chamber 25, and optional lid 40 can be placed onto pot 10 as with standard pots. Of not is that pot 10 is now shown sitting on stovetop 4 and encompassing gas burner 3. Thus, burner 3 is within chamber 35 of the lower portion 20 of the pot. As the heat is applied to bottom 21 it is trapped within the chamber 35 increasing thermal efficiency. Holes 31 allow for airflow, thereby maintaining oxygen supply to burner 3 such that the flame is not extinguished.

Looking now to FIG. 5, a second embodiment of the invention is shown. Here pan 200 is adapted for use with a bottom portion 230 similar to that of those shown in FIG. 4. As can be seen pan 200 is similar to pot 10, but can be used in a variety of other cooking deployments. Bottom portion encompasses burner 3 and sits upon stovetop 4 creating chamber 235 underneath pan bottom 221. Pan bottom 221 and bottom portion 230 connect at point 226 which may have handle or handles 224. Food is cooked in cooking area 225.

Although all of the possible embodiments are not shown it would be known to those in that art that implementations of variants of the bottoms shown in FIGS. 2 & 3 can be combined with those embodiments shown in FIGS. 1-5.

### INDUSTRIAL APPLICABILITY AND CONSTRUCTION

Pot 10 or pan 200 can be combined with bottom portion 30 or 300 to provide different embodiments of the invention. In particular these pots can be made using a variety of materials known in the art such as steel, cast iron, ceramics, and even nonstick surfaces (such as PTFE). The choice of material is up to the user and manufacturer, however it behooves the manufacturer to choose stronger materials with the ability to insulate for the bottom portion 30 (aka skirt) of the pots and pans as this portion will provide the bulk of the insulation as well as endure significant physical abuse during use. Therefore glues are generally discouraged in this part of the manufacture.

As most consumer grates are approximately ¾″ to 1″ from the stovetop, this is a generally recommended height for the bottom 21 of a typical pot 10 or pan 200. However, varying heights may be preferred depending on the manufacturer of a given stovetop.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

1. A cooking vessel for energy efficient cooking using a gas burner comprising:
an upper portion having a sidewall and a bottom, the sidewall and bottom defining a cooking chamber, and having a top edge, and a lip, the lip protruding inwards from an inner side of the sidewall nearer the top edge than the bottom;
a lower portion, the lower portion connected to the upper portion and extending downwardly past the sidewall, the lower portion having a consistent circumference and extending past the bottom of the upper portion such that the bottom of the upper portion is suspended when the cooking vessel is placed on a flat surface, forming a heating chamber under the cooking chamber;
wherein the lower portion allows airflow through the heating chamber;
wherein the lower portion has holes around its circumference to facilitate airflow in the heating chamber.

2. The cooking vessel of claim 1 wherein:
the holes are spaced evenly around the lower portion.

3. The cooking vessel, of claim 1 wherein:
the lower portion, having a bottom, the bottom having triangular cut outs at the bottom of the lower portion to facilitate airflow in the heating chamber.

4. The cooking vessel of claim 1 wherein:
the lower portion extends at least ½″ beyond the bottom of the upper portion.

5. The cooking vessel of claim 1 wherein:
the cooking chamber is a round bottomed pot.

6. The cooking vessel of claim 5 further comprising:
two handles located on the cooking vessel.

7. The cooking vessel of claim 1 wherein:
the cooking chamber is a cooking pan.

8. The cooking vessel of claim 7 further comprising:
an insulated handle.

9. A cooking pot comprising:
a round bottomed pot, the round bottomed pot having a rounded bottom and a circular sidewall, the sidewall and bottom forming a cooking chamber; and
a circular skirt, the skirt having a consistent circumference and connected to the sidewall and extending downwardly beyond the bottom of the round bottomed pot, thereby forming a heating chamber below the round bottomed pot, the skirt having the same circumference as the sidewall;
and wherein the rounded bottom of the round bottomed pot abuts the sidewall of the cooking chamber and forms a point where the sidewall intersects the circular skirt.

10. The cooking pot of claim 9 further comprising:
holes cut into the skirt, said holes for promoting airflow through the heating chamber and the holes are spaced evenly around the skirt.

11. The cooking pot of claim 10 wherein:
the skirt extends at least ½″ beyond the bottom of the round bottomed pot.

12. The cooking pot of claim 11 wherein:
the skirt extends at least 1″ beyond the bottom of the round bottomed pot.

13. The cooking pot of claim 10 wherein:
the skirt and the sidewall are formed from a single piece of metal.

14. The cooking pot of claim 9 further comprising:
triangular cutouts cut into the skirt, said cutouts for promoting airflow through the heating chamber.

15. (canceled)

16. A cooking pot comprising:
a round bottomed pot, the round bottomed pot having a rounded bottom and a circular sidewall, the sidewall and bottom forming a cooking chamber; and
a circular skirt, the skirt connected to the sidewall and extending downwardly beyond the bottom of the round bottomed pot, thereby forming a heating chamber below the round bottomed pot, the skirt having the same circumference as the sidewall;
wherein the rounded bottom of the round bottomed pot abuts the sidewall of the cooking chamber and forms a point where the sidewall intersects the circular skirt;
triangular cutouts cut into the skirt, said cutouts for promoting airflow through the heating chamber.
